(19) United States
(12) Patent Application Publication
(10) Pub. No.: US 2009/0183712 A1
(43) Pub. Date: Jul. 23, 2009

(54) IDLE SPEED ADJUSTMENT SYSTEM

(76) Inventors: Richard Owens, Powell, OH (US); Nick Scheufler, Dublin, OH (US)

Correspondence Address: Fay Sharpe LLP, 1228 Euclid Avenue, 5th Floor, The Halle Building, Cleveland, OH, 44115, US

(21) Appl. No.: 12/017,831

(22) Filed: Jan. 22, 2008

(51) Int. Cl. F02D 41/08; F02M 3/09

(52) U.S. Cl. 123/339.18; 123/339.1

(57) ABSTRACT

An engine idle control system is provided in a vehicle having an engine that drives an electric power generator arranged to selectively provide electric power to an electrical load of the vehicle and to selectively charge a battery of the vehicle. The engine idle control system includes: a sensor that detects a state of charge (SOC) of the battery; and a controller that controls an idle speed of the engine in response to the SOC detected by the sensor, wherein the controller is provisioned to skip at least one specific engine idle speed that has been identified as a cause of at least one of: unwanted noise in the vehicle; unwanted vibrations in the vehicle; undesirable emissions control; or undesirable driveline torque.

### BACKGROUND

The present specification relates generally to the automotive arts. More specifically, the present specification relates to an idle speed control system and/or method that adjusts or otherwise regulates the idle speed of a vehicle's engine in response to a detected state of charge (SOC) of the vehicle's battery. Particular application is found in connection with an electrical system of a motor vehicle (e.g., an automobile or other vehicle driven by an internal combustion engine), and the specification makes particular reference thereto. However, it is to be appreciated that aspects of the present subject matter are also amenable to other like applications.

As is known in the art, an automotive vehicle generally includes an engine that drives the vehicle. A modern vehicle is also typically provisioned with an electrical system including a battery which provides a source of electrical power for starting the vehicle and one or more electric circuits or loads (e.g., headlights, clocks, electrically powered adjustable components such as seats, mirrors or steering columns, interior cabin lights, electric heaters for seats, mirrors, windows or the like, radios and/or other entertainment systems, etc.) that may also be selectively powered by the vehicle's battery.

Typically, the vehicle's electrical system also includes an alternating current generator (ACG) or other like device that is driven by the engine to produce electric power when the engine is running. An ACG is also commonly known as an alternator and in a more general case the electric power producing device may simply be a generator. For the sake of convenience however, the term ACG has generally been used in the present specification. Nevertheless, as used herein, any of the terms and/or devices (i.e., ACG, alternator or generator) may suitably be substituted for any other term or device as deemed appropriate for particular applications.

Generally, the ACG is arranged to selectively provide electric power to the aforementioned loads and/or to charge the battery. The amount of electric power produced and/or output by the ACG is generally dependent upon the rotational speed at which the ACG is driven and accordingly upon the rotational speed of the engine which is driving the ACG. That is to say, when the engine is operating at a relatively lower rpm (revolutions per minute), then the output of the ACG is correspondingly lower and when the engine is operating at a relatively higher rpm, then the output of the ACG is correspondingly higher.

As can be appreciated, while the vehicle engine is idling, changes in the operation of various different electric loads may affect the SOC of the battery. For example, an increase in the use of electric power by the electric loads may tend to result in an undesirable reduction in the SOC of the battery. Accordingly, in such cases it is generally advantageous to increase the idle speed of the engine so as to produce more electric power output from the ACG to thereby compensate for the increased demand from the loads and/or suitably provide for charging of the battery to promote desired SOC recovery. Alternately, when the battery SOC is sufficiently high, it is generally desirable to maintain the idle speed of the engine relatively low insomuch as obtaining additional electrical power output from the ACG is not a concern and the lower engine idle speed tends to conserve fuel.

It is therefore generally advantageous, for at least the aforementioned reasons, to adjust engine idle speeds up or down and thereby regulate or otherwise control the ACG electric power output to compensate for changes in the operation of the various different electric loads and/or to maintain a desired battery SOC. However, at particular engine idle speeds, undesired noises or vibrations can be generated or otherwise experienced in the vehicle's engine, exhaust or at other locations, e.g., due to resonance or other causes. If significant enough, such noises or vibrations can cause a driver and/or passenger of the vehicle to be dissatisfied and/or uncomfortable with the driving experience. Additionally, at particular idle speeds, emissions control may be suboptimal and/or driveline (i.e., transmission) torque and/or losses may increase.

Accordingly, a new and improved system and/or method is disclosed that overcomes the above-referenced problems and others by controlling the engine idle speed in response to the detected SOC of the battery while avoiding selected engine idle speeds, e.g., identified as being associated with an undesirable generation of noise and/or vibrations; undesirable driveline and/or transmission torque and/or losses; and/or undesirable emissions control.

### SUMMARY

According to one aspect, an engine idle control system is provided in a vehicle having an engine that drives an electric power generator arranged to selectively provide electric power to an electrical load of the vehicle and to selectively charge a battery of the vehicle. The engine idle control system includes: a sensor that detects a state of charge (SOC) of the battery; and a controller that controls an idle speed of the engine in response to the SOC detected by the sensor, wherein the controller is provisioned to skip at least one specific engine idle speed that has been identified as a cause of at least one of: unwanted noise in the vehicle; unwanted vibrations in the vehicle; undesirable emissions control; or undesirable driveline torque.

According to another aspect, an engine idle control system is provided in a vehicle having an engine that drives an electric power generator arranged to selectively provide electric power to an electrical load of the vehicle and to selectively charge a battery of the vehicle. The engine idle control system includes: sensing means for detecting a state of charge (SOC) of the battery; and control means for controlling an idle speed of the engine in response to the SOC detected by the sensing means, wherein the control means is provisioned to skip at least one specific engine idle speed that has been identified as a cause of at least one of: unwanted noise in the vehicle; unwanted vibrations in the vehicle; undesirable emissions control; or undesirable driveline torque.

According to still another aspect, a method for controlling a idle speed of the engine is provided in a vehicle having an engine that drives an electric power generator arranged to selectively provide electric power to an electrical load of the vehicle and to selectively charge a battery of the vehicle. The method includes: identifying an engine idle speed that is a cause of at least one of: unwanted noise in the vehicle; unwanted vibrations in the vehicle; undesirable emissions control; or undesirable driveline torque; determining a state of charge (SOC) of the battery; and adjusting the idle speed of the engine in response to the determined SOC of the battery, wherein said adjustment of the idle speed of the engine is executed such that the identified engine idle speed is avoided.

### BRIEF DESCRIPTION OF THE DRAWINGS

FIG. 1 is a schematic diagram showing an exemplary engine idle speed control system of a vehicle suitable for practicing aspects of the present disclosed subject matter.

FIG. 2 is a graph showing an exemplary plot of engine idle speed as a function of battery SOC in accordance with aspects of the present disclosed subject matter.

### DETAILED DESCRIPTION

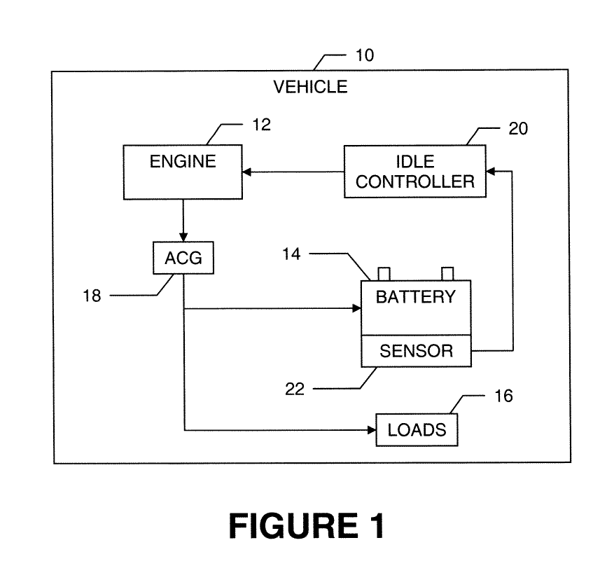

Referring now to the drawings, wherein the showings are for purposes of illustrating one or more exemplary embodiments, FIG. 1 shows a schematic diagram of an engine idle speed control system for a vehicle 10, e.g., such as an automobile or other similar automotive vehicle. As shown, the vehicle 10 includes an engine 12 (e.g., an internal combustion engine or the like) that drives the vehicle 10. The vehicle 10 is also provisioned with an electrical system including: a battery 14 which suitably provides a source of electrical power for starting the vehicle 10; and, one or more electric circuits or loads that may also be selectively powered by the vehicle's battery 14. As illustrated in FIG. 1, the loads are collectively represented by box 16 and may include, e.g., headlights, clocks, electrically powered adjustable components such as seats, mirrors or steering columns, interior cabin lights, electric heaters for seats, mirrors, windows or the like, radios and/or other entertainment systems, etc. Suitably, the battery is a nominal 12 volt (v) battery of the type commonly employed in automobiles or may be any other type of battery, e.g., typically used in automotive applications.

In the illustrated embodiment, the vehicle 10 also includes an ACG 18 or other like device that is driven by the engine 12 to produce electric power when the engine 12 is running. For example, the ACG 18 may be any type of alternator or other current generator commonly known and/or employed in the automotive arts. Suitably, the ACG 18 is arranged to selectively provide electric power to the loads 16 and/or to charge the battery 14. The amount of electric power produced and/or output by the ACG 18 is generally dependent upon the rotational speed at which the ACG 18 is driven and accordingly upon the rotational speed of the engine 12 which is driving the ACG 18. That is to say, when the engine 12 is operating at a relatively lower rpm, then the output of the ACG 18 is correspondingly lower and when the engine 12 is operating at a relatively higher rpm, then the output of the ACG 18 is correspondingly higher.

Suitably, the vehicle 10 also includes an engine idle speed controller 20 that regulates and/or otherwise controls the idle speed of the engine 12 in response to or as a function of the SOC of the battery 14. As shown, the SOC of the battery 14 is obtained by the controller 20 from a sensor unit or sensor 22 operatively connected to the battery 14 so as to sense and/or otherwise detect the SOC of the battery 14.

More specifically, for example, the controller 20 receives a signal representative of a condition or SOC of the battery 14 from the sensor 22. In the illustrated embodiment, the sensor 22 is electrically connected to the battery 14 for determining the condition of the battery 14 and generating the SOC signal representative thereof to send to the controller 20. The SOC signal can be one or more signals that indicate the condition or SOC of the battery 14. The condition can be a value indicating the charge remaining in the battery 14 relative to a scale ranging between a low end where no charge remains in the battery 14 and a high end where the battery 14 is fully charged. In one suitable embodiment, the SOC signal indicates the condition of the battery 14 as related to its overall charge capacity (i.e., a value or percentage of a maximum SOC of the battery 14). In another exemplary embodiment, the SOC signal indicates the percentage of maximum electrical energy output of the battery 14.

In either event, suitably the sensor unit or sensor 22 measures or otherwise detects any one or more of a variety of different factors and/or parameters from which the battery's SOC is calculated or otherwise determined. These factors or parameters suitably include but are not limited to, the battery voltage, battery current, charge balance, battery temperature, etc. Any of a variety of well known or otherwise appropriate methods and/or algorithms may optionally be used to calculate or determine the SOC from the respective parameters measured or otherwise obtained by the sensor 22.

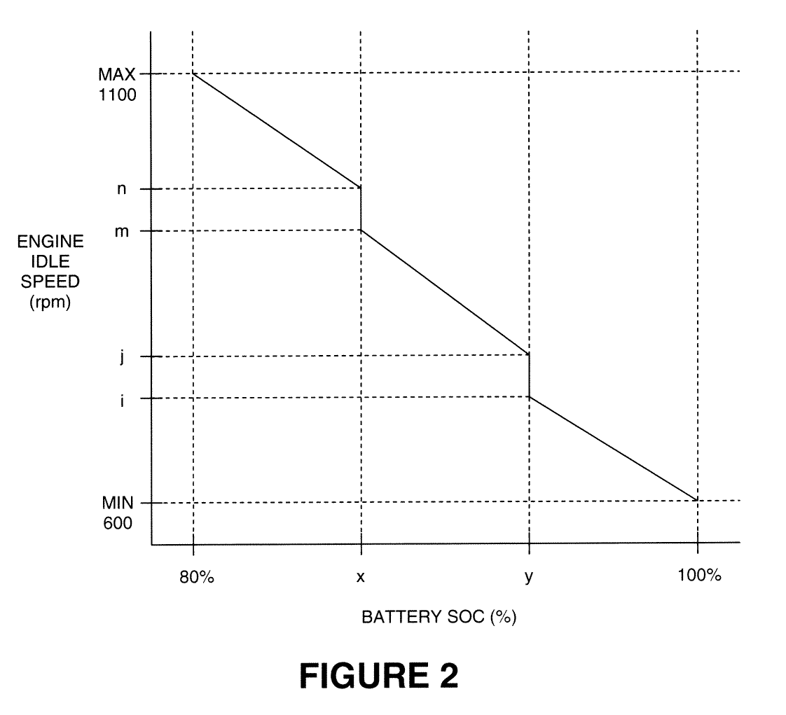

With additional reference to FIG. 2, the controller 20 controls the idle speed of the engine 12 based on and/or in response to the SOC signal received from the sensor 22. Suitably, the engine idle speed is adjusted via any one or more of a variety of well known and/or appropriate techniques, e.g., by regulating the throttle or fuel injection, adjusting the fuel to air ratio, or controlling other engine speed determining factors and/or parameters. Depending on the battery SOC, the engine idle speed is suitably adjusted by the controller 20 to a selected or determined value between a minimum idle speed (e.g., 600 rpm) and a maximum idle speed (e.g., 1100 rpm). Generally, in accordance which a prescribed algorithm or function, the controller 20 sets or selects a relatively higher engine idle speed in response to a relatively lower SOC and conversely sets or selects a relatively lower engine idle speed in response to a relatively higher SOC. For example, as shown in FIG. 2, the minimum engine idle speed is set when the battery SOC is at or around 100% and the maximum engine idle speed is set when the battery SOC is at or around 80%.

In addition to controlling the engine idle speed based on the SOC, the controller 20 is also programmed or otherwise provisioned to skip or avoid one or more selected engine idle speeds or ranges that have been identified as a cause of: unwanted noise in the vehicle 10; unwanted vibrations in the vehicle 10; undesirable emissions control; and/or undesirable driveline torque. In practice, one or more idle speeds or ranges are first identified at which the unwanted effects are generated and/or at which the undesired results manifest. Suitably, these idles speeds and/or ranges are identified, e.g., via testing, modeling or otherwise. Accordingly, the idle adjustment and/or control algorithm utilized by the controller 20 is then modified or designed to skip or otherwise avoid these identified idle speeds or ranges. For example, as shown in FIG. 2, the engine idle speeds in the ranges from i to j and from m to n may have been identified as causing unwanted noise or vibrations at some location in the vehicle 10 due to resonance or otherwise or these ranges may have been identified as resulting in suboptimal emissions control and/or an undesired increase in driveline or transmission torque and/or losses. Therefore, as the SOC approaches the values x or y, the aforementioned engine idle speeds or ranges are avoided or skipped by the controller 20. As can be appreciated, the skipping of selected engine idle speeds or ranges is reflected by the corresponding discontinuities in the illustrated graph.

Suitably, the controller 20 calculates the engine idle speed as a function of the SOC received from the sensor 22. That is to say, the controller 20 may optionally execute an equation such as IS=f(SOC), where IS represents the calculated engine idle speed and f(SOC) represents a function of the SOC received from the sensor 22. The function f optionally maps a particular input SOC to a desired corresponding engine idle speed. For example, FIG. 2 illustrates one form of a suitable function f. Of course, alternately, the function f may take any other desired or appropriate form for the particular application or vehicle in question. In another alternate embodiment, the controller 20 is provisioned with a look-up table (LUT) or the like that relates battery SOC to engine idle speed. Accordingly, the controller 20 selects an engine idle speed from the LUT based on the SOC signal received from the sensor 22.

Of course, the idle speed, SOC and/or other values illustrated in FIG. 2 are merely examples. It is to be appreciated that in practice the actual values may be varied to suit particular applications as desired.

While one or more of the various embodiments have been described herein with reference to the battery's SOC, it is to be appreciated that SOC is merely an exemplary parameter that is sensed, measured and/or otherwise determined and accordingly used in one or more suitable manners as explained above. More generally and/or in alternate embodiments, other parameters indicative of and/or related to the battery's state of function (SOF) may similarly be obtained (i.e., sensed, measured and/or otherwise determined) and suitably used in place of the SOC. In this regard, examples of the battery's SOF include not only the battery's SOC but also the battery's cranking voltage, the internal resistance of the battery, the battery's reserve capacity, the cold cranking amperes (CCA) of the battery, the battery's health and the like. Accordingly, it is intended that the terms and/or parameters SOC and SOF when used herein may optionally be interchanged where appropriate to achieve various alternate embodiments suitable for particular desired applications.

In any event, it is to be appreciated that in connection with the particular exemplary embodiments presented herein certain structural and/or function features are described as being incorporated in defined elements and/or components. However, it is contemplated that these features may, to the same or similar benefit, also likewise be incorporated in common elements and/or components where appropriate. For example, the sensor 22 and controller 20 may suitably be integrated together. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. For example, the controller 20 and/or sensor 22 may be implemented as appropriate hardware circuits or alternately as microprocessors programmed to implement their respective functions. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, it will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. In a vehicle having an engine that drives an electric power generator arranged to selectively provide electric power to an electrical load of the vehicle and to selectively charge a battery of the vehicle, an engine idle control system comprising:
a sensor that detects a state of charge (SOC) of the battery; and
a controller that controls an idle speed of the engine in response to the SOC detected by the sensor, wherein said controller is provisioned to skip at least one specific engine idle speed that has been identified as a cause of at least one of: unwanted noise in the vehicle; unwanted vibrations in the vehicle; undesirable emissions control; or undesirable driveline torque.

2. The engine idle control system of claim 1 wherein the idle speed of the engine is adjustable between a maximum engine idle speed and a minimum engine idle speed.

3. The engine idle control system of claim 2 wherein the skipped specific engine idle speed is between the maximum and minimum engine idle speeds.

4. The engine idle control system of claim 3 wherein the controller controls the idle speed of the engine so as to achieve a relatively higher engine idle speed in response to a relatively lower SOC detected by the sensor and a relatively lower engine idle speed in response to a relatively higher SOC detected by the sensor.

5. The engine idle control system of claim 4 wherein the generator generates electric power in proportion to a rotational speed at which the generator is driven by the engine.

6. The engine idle control system of claim 5 wherein the rotational speed at which the generator is driven by the engine is proportional to a rotational speed at which the engine is operated.

7. The engine idle control system of claim 6 wherein the generator is an alternating current generator.

8. In a vehicle having an engine that drives an electric power generator arranged to selectively provide electric power to an electrical load of the vehicle and to selectively charge a battery of the vehicle, an engine idle control system comprising:
sensing means for detecting a state of charge (SOC) of the battery; and
control means for controlling an idle speed of the engine in response to the SOC detected by the sensing means, wherein said control means is provisioned to skip at least one specific engine idle speed that has been identified as a cause of at least one of: unwanted noise in the vehicle; unwanted vibrations in the vehicle; undesirable emissions control; or undesirable driveline torque.

9. The engine idle control system of claim 8 wherein the idle speed of the engine is adjustable between a maximum engine idle speed and a minimum engine idle speed.

10. The engine idle control system of claim 9 wherein the skipped specific engine idle speed is between the maximum and minimum engine idle speeds.

11. The engine idle control system of claim 10 wherein the control means controls the idle speed of the engine so as to achieve a relatively higher engine idle speed in response to a relatively lower SOC detected by the sensing means and a relatively lower engine idle speed in response to a relatively higher SOC detected by the sensing means.

12. The engine idle control system of claim 11 wherein the generator generates electric power in proportion to a rotational speed at which the generator is driven by the engine.

13. The engine idle control system of claim 12 wherein the rotational speed at which the generator is driven by the engine is proportional to a rotational speed at which the engine is operated.

14. The engine idle control system of claim 13 wherein the generator is an alternating current generator.

15. In a vehicle having an engine that drives an electric power generator arranged to selectively provide electric power to an electrical load of the vehicle and to selectively charge a battery of the vehicle, a method for controlling a idle speed of the engine comprising:
(a) identifying an engine idle speed that is a cause of at least one of: unwanted noise in the vehicle; unwanted vibrations in the vehicle; undesirable emissions control; or undesirable driveline torque;
(b) determining a state of charge (SOC) of the battery; and
(c) adjusting the idle speed of the engine in response to the determined SOC of the battery, wherein said adjustment of the idle speed of the engine is executed such that the identified engine idle speed is avoided.

16. The method of claim 15 wherein the idle speed of the engine is adjustable between a maximum engine idle speed and a minimum engine idle speed.

17. The method of claim 16 wherein the identified engine idle speed is between the maximum and minimum engine idle speeds.

18. The method of claim 17 wherein the idle speed of the engine is adjusted so as to achieve a relatively higher engine idle speed in response to a relatively lower SOC and a relatively lower engine idle speed in response to a relatively higher SOC.

19. The method of claim 18 wherein the generator generates electric power in proportion to a rotational speed at which the generator is driven by the engine.

20. The method of claim 19 wherein the rotational speed at which the generator is driven by the engine is proportional to a rotational speed at which the engine is operated.
